(19) United States
(12) Patent Application Publication
(10) Pub. No.: US 2023/0023029 A1
(43) Pub. Date: Jan. 26, 2023

(54) METHOD AND APPARATUS PERTAINING TO MACHINE LEARNING AND MATRIX FACTORIZATION TO PREDICT ITEM INCLUSION

(71) Applicant: Walmart Apollo, LLC, Bentonville, AR (US)

(72) Inventors: Gautam Chandra, Sunnyvale, CA (US); Anusha Reddy Narapureddy, Milpitas, CA (US); Zhaoyu Li, Cupertino, CA (US)

(21) Appl. No.: 17/865,014

(22) Filed: Jul. 14, 2022

Related U.S. Application Data
(60) Provisional application No. 63/221,591, filed on Jul. 14, 2021.

(51) Int. Cl. G06Q 30/02; G06N 3/04; G06K 9/62

(52) U.S. Cl. CPC G06Q 30/0201; G06N 3/049; G06K 9/6223

(57) ABSTRACT

A control circuit accesses a memory having time series acquisition history data for members of a predetermined group. That control circuit is configured to predict at least one future aggregation of items on a per-member basis by (1) using machine learning to predict specific items in the at least one future aggregation of items, wherein the machine learning uses a training corpus comprising, at least in part, the aforementioned time series acquisition history data, and (2) using matrix factorization to predict a quantity of at least some of the specific items in the at least one future aggregation of items.

### CROSS-REFERENCE TO RELATED APPLICATION(S)

This application claims the benefit of U.S. Provisional Application No. 63/221,591, filed Jul. 14, 2021, which is incorporated by reference in its entirety herein.

### TECHNICAL FIELD

These teachings relate generally to machine learning.

### BACKGROUND

Planning a successful promotion can increasingly involve consideration of numerous variables, some unique to potential consumers and some not. The applicant has determined that it can be useful to understand possible and/or likely future consumer behavior in these regards.

### BRIEF DESCRIPTION OF THE DRAWINGS

The above needs are at least partially met through provision of the method and apparatus pertaining to machine learning and matrix factorization to predict item inclusion described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings;

FIG. 3 comprises a block diagram as configured in accordance with various embodiments of these teachings; and

FIG. 4 comprises a graph as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, pursuant to these various embodiments, a control circuit accesses a memory having time series acquisition history data for members of a predetermined group. That control circuit is configured to predict at least one future aggregation of items on a per-member basis by (1) using machine learning to predict specific items in the at least one future aggregation of items, wherein the machine learning uses a training corpus comprising, at least in part, the aforementioned time series acquisition history data, and (2) using matrix factorization to predict a quantity of at least some of the specific items in the at least one future aggregation of items.

By one approach the machine learning comprises a convolutional neural network including, more particularly, a temporal convolutional neural network. By one approach, the temporal convolutional neural network comprises a causal dilated temporal convolutional neural network.

By one approach, the control circuit can be further configured to generate clusters of the aforementioned members. By one approach the control circuit so generates these clusters as a function, at least in part, of acquisition history, item information, and/or member information. The aforementioned clustering can be generated, by one approach, via supervised clustering. In lieu of the foregoing or in combination therewith, the aforementioned clustering can be generated via unsupervised clustering. In such a case, the unsupervised clustering can comprise using at least one of term frequency-inverse document frequency, K-means clustering, and singular value decomposition.

By one approach, the control circuit can be further configured to provide, via a user interface, strategies pertaining to the aforementioned members as a function, at least in part, of the prediction of at least one future aggregation of items on a per-member basis, the clusters of the members, and/or at least one user-specified offering strategy limiting parameter.

So configured, these teachings can facilitate a variety of purposes. As one example, these teachings will facilitate using a user prescribed budget for promotions and demonstrating various models to achieve the goals of the promotion. By one approach these teachings will permit creating a personalized promotion for members of a given group given a user-specified promotion budget. These teachings will facilitate any of item-based promotions and member-based promotions.

Participation by a given group member in such a program can of course be made contingent upon the member's specific informed election to so participate and further presuming that such a program and such participation is otherwise not precluded by applicable laws or regulations.

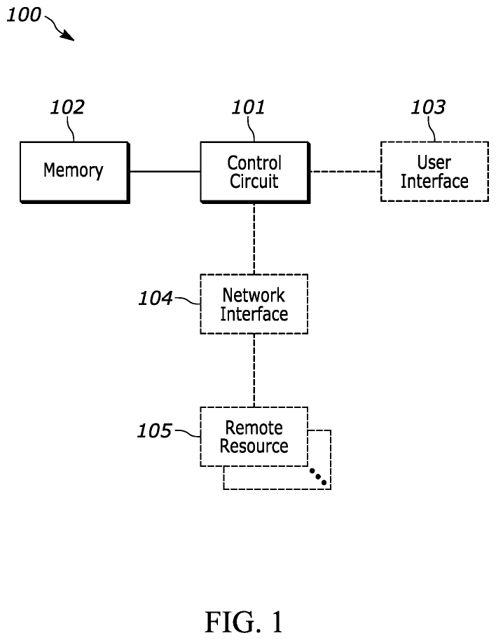

These and other benefits may become clearer upon making a thorough review and study of the following detailed description. Referring now to the drawings, and in particular to FIG. 1, an illustrative apparatus 100 that is compatible with many of these teachings will first be presented. For the sake of an illustrative example it will be presumed here that a control circuit of choice carries out some or all of the actions, steps, and/or functions of the teachings presented herein.

In this particular example, the enabling apparatus 100 includes such a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

This description presumes that the control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101).

In addition to the aforementioned time series acquisition history data, this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as a dynamic random access memory (DRAM).)

By one optional approach, the control circuit 201 operably couples to a user interface 103. This user interface 103 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

If desired, the control circuit 101 also operably couples to a network interface 104. So configured the control circuit 101 can communicate with other elements (both within the apparatus 100 and external thereto) via the network interface 104. Network interfaces, including both wireless and non-wireless platforms, are well understood in the art and require no particular elaboration here. The aforementioned “other elements” may include, for example, one or more remote resources that provide data to be processed and/or leveraged per these teachings.

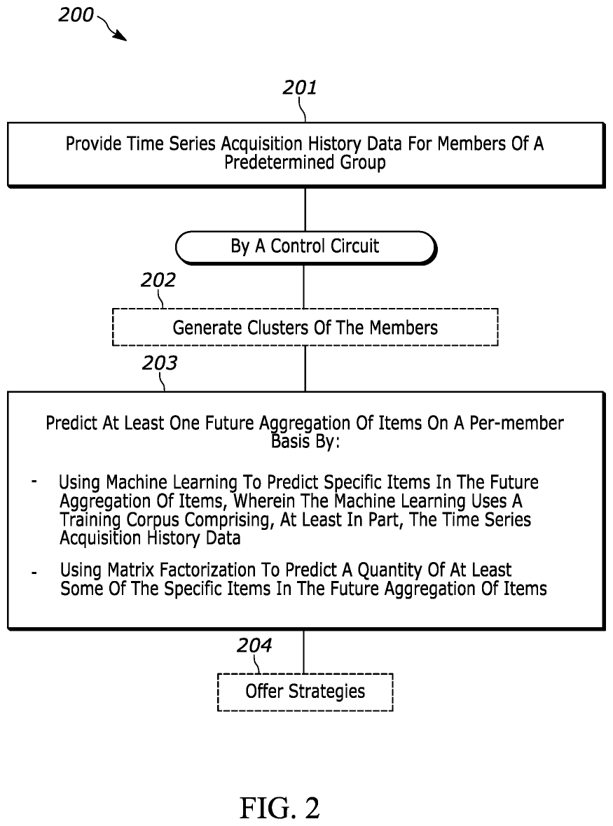

Referring now to FIG. 2, a process 200 that can be carried out in conjunction with the above-described apparatus 100 will be described.

At block 201, this process 200 provides time series acquisition history data for members of a predetermined group. This information can be stored in and accessed from, for example, the above-described memory 102. For the sake of an illustrative example, the predetermined group may comprise members of a buying club. By one approach, only current members of the buying club are considered. By another approach, both current and past members of the buying club are considered. Also for the sake of an illustrative example, the aforementioned time series acquisition history data can include information regarding specific items acquired by individual members, and the number of each such item acquired by each individual member, per a temporal measure of choice. For example, such activity may be parsed on a monthly basis, a weekly basis, a daily basis, and/or on a per-event basis as desired.

By one approach, the time series acquisition history data reflects all acquisitions by each member from a given source (such as a given online site and/or a given retailer). By another approach, the time series acquisition history data can reflect one or more specific categories of items (such as nonperishable items, consumable items, apparel items, and so forth) such that at least some of acquired items are ultimately not included in the time series acquisition history data for failure to fall within a monitored category.

The time series acquisition history data can encompass a duration of choice. In many application settings a longer duration may provide more satisfactory results than a shorter duration. For example, six months' worth of data may be more helpful than six weeks' worth of data, and one year worth of data may be more helpful than six months' worth of data.

In this illustrative example, it is presumed that the remaining steps, actions, and functionality are carried out by the aforementioned control circuit 101.

At optional block 202, the control circuit 101 can generate clusters of the members. By one approach the control circuit 101 generates such clusters as a function, at least in part, of one or more of the corresponding acquisition history, item information, and member information. The acquisition history may constitute, for example, the order history for each member. By one approach, only online orders may be considered. By another approach, only in-store activity may be considered. By yet another approach, all acquisition activity, at least from a particular retailer source, may be considered. The aforementioned member information can include, for example, information regarding whether a given member utilizes a home delivery service, whether they observe a vegan lifestyle, and so forth.

By one approach the control circuit 101 generates such clusters via supervised clustering. In this case, a user may specify, for example, particular clustering categories and/or classification attributes that correspond to particular clustering categories.

By another approach, in lieu of the foregoing or in combination therewith, the control circuit 101 may generate at least some of the clusters via unsupervised clustering. In such a case, the control circuit 101 may utilize methodologies such as term frequency-inverse document frequency, K-means clustering, and/or singular value decomposition dimension reduction.

Generally speaking, this clustering activity can serve to divide the members into groups that share similar attributes, such as similar shopping patterns. When using clustering, that clustering information can be organically leveraged by the control circuit 101 when carrying out the remaining aspects of this process 200.

At block 203, the control circuit 101 predicts at least one future aggregation of items on a per-member basis. In this particular illustrative example, the control circuit 101 employees both machine learning and matrix factorization to accomplish this activity.

More particularly, the control circuit 101 uses machine learning to predict specific items in the at least one future aggregation of items. By one approach, this machine learning uses a training corpus comprising, at least in part, the aforementioned time series acquisition history data. By one approach the machine learning comprises a convolutional neural network and more particularly a temporal convolutional neural network (such as a causal dilated temporal convolutional neural network) to predict the items to be acquired.

The aforementioned matrix factorization can serve to predict a quantity of at least some of the specific items predicted via the machine learning activity. In particular, these teachings will accommodate using an explicit feedback matrix factorization model. This approach uses latent vectors to represent both members and items. The dot product of such vectors yields a predicted score for a given member-item pairing. More particularly, that score represents the quantity of such items.

The hyper parameters used in one illustrative model in these regards are as follows:

| Hyper Parameter | Value |
|---|---|
| Loss Function | RMSE |
| Embedding Dimension | 128 |
| Total Number of Training Epochs | 40 |
| Training Batch Size | 1024 |
| L2 Regularization | 1e−9 |
| Learning Rate | 1e−3 |
| Gradient Decent Optimizer | Adam |

These teachings will accommodate, for example, training 40 epochs and choosing the model at the 15th epoch as a final model. If desired, all the above predictions are written to an SQLite database in advance to save real-time computing time.

The foregoing activity yields information that can serve, for example, to predict future shopping carts of individual members. These predictions can include both specifically identified items and their respective quantities. At optional block 204, this process 200 will then accommodate providing, via a user interface 103, offered strategies for the aforementioned members as a function, at least in part, of the prediction of at least one future aggregation of items on a per-member basis, the aforementioned clusters of the members, and at least one user-specified offering strategy limiting parameter. The latter may comprise, for example, a monetary budget and/or a time-based limitation or target. The aforementioned strategies may include, for example, particular promotions.

So configured, these teachings can help to best leverage a promotional budget in favor of particular desired levels of consumer activity. By one approach these teachings will permit creating personalized promotions for members of given groups to thereby increase member involvement for a given budget. Member-based promotions these teachings will support item-based promotions as well as category-based promotions.

A more specific example will now be presented. It will be understood that the details of the following description are not intended to suggest any particular limitations with respect to these teachings.

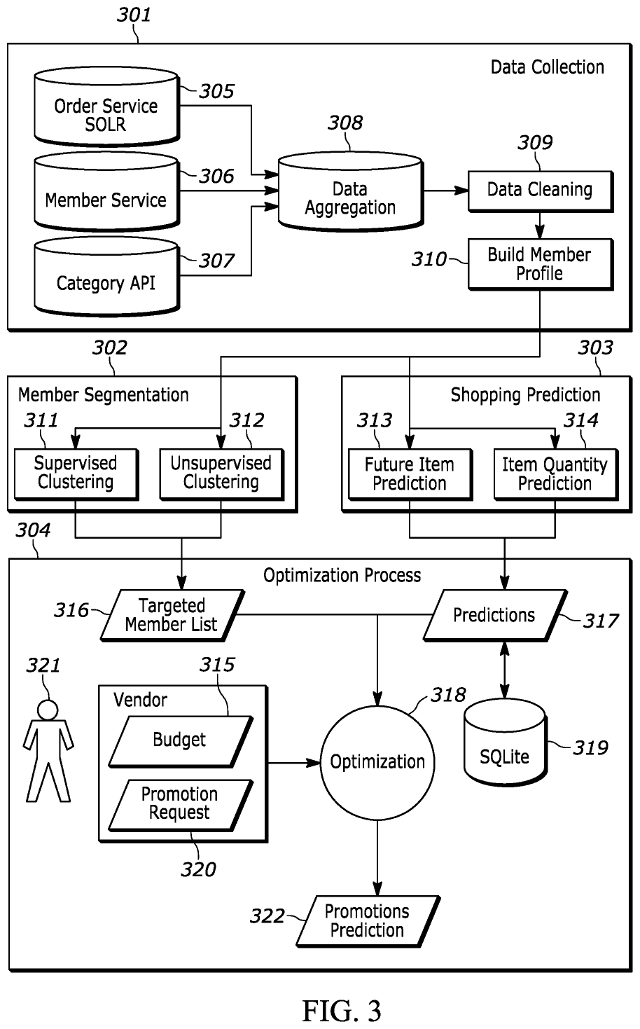

FIG. 3 presents a detailed schematic view for the design and architecture of a system that comports with many of the aforementioned teachings. This system as depicted includes four major elements, these being a data collection element 301, a member segmentation element 302, a shopping prediction element 303, and an optimization element 304.

The Data Collection Element 301

This example presumes the availability of three or more data sources. The first data source 305 sources data representing online ordering and shopping activity. This information can include, for example, universal product code (UPC) information corresponding to items that were ordered by members from an online source during some selected period of time. The second data source 306 provides information regarding the members themselves. Such information can be personal and specific and/or categorical and general. Examples include but are not limited to residential address information, demographics information, affinity information (such as preferences regarding green products, thriftiness, veganism, and so forth). The third data source 307 provides category-based information. Examples include but are not limited to product category hierarchy (such as Grocery as a parent category having many sub-categories, such as, Fresh Food, Pantry, Candy, Beverages, etc.), category descriptions, etc. As noted, these teachings can make use of additional data sources depending upon the needs and/or opportunities represented by a given application setting. As one example in these regards, yet another data source can source data representing promotion transaction history. This information includes but not limited to, for example, all promotions applied to the member in the past with the promotion's detailed information, the items that the promotions are applied to, and the discounted values of the transaction, etc.

In this example, information from these data sources is aggregated at a point of data aggregation 308. The data collection element 301 then provides a data cleaning element 309 that receives the aggregated data and cleans it. More specifically, in this example the data cleaning element 309 removes: (1) information that corresponds to a reseller's account; (2) duplicate rows of information; (3) information regarding orders from massive buyers (i.e., buys who enter more than some predetermined number of orders, such as 1000 orders); (4) information regarding orders that were returned or cancelled; and (5) otherwise empty orders. The specific nature of such data cleaning can and will of course vary with the needs and/or opportunities presented in a given application setting.

The data collection element 301 then builds member profiles 310 that includes information regarding items that were ordered in noted quantities (and, for example, in combination with other specified items).

The Member Segmentation Element 302

In this illustrative example the member segmentation element 302 provides both supervised clustering 311 and unsupervised clustering 312 of member information.

As regards supervised clustering 311, this example provides for pre-defining some member groups, such as members who have not previously used home delivery service, members who have not previously used pickup service, members who likely have a baby in their family, who have bought vegetables but never any meat products, and members who have only placed orders during weekend hours. In this example, supervised clustering is applied only to member service information as sourced by the aforementioned second data source 306.

As regards unsupervised clustering 312, this example provides for using member's shopping category history to build member profile vectors to find groups in which all members share the same shopping pattern similarity. The user group clusters are based on “leaf node” categories. For each cluster, an example of an embedded member profile might be represented as follows:

| | cat1 | cat2 | . . . | cat3 | cat4 |
|---|---|---|---|---|---|
| member1 | 0 | 5 | . . . | 2 | 0 |
| member2 | 1 | 0 | . . . | 5 | 2 |
| . . . | . . . | . . . | . . . | . . . | . . . |

In this example, embedding uses the number of occurrences rather than appearances.

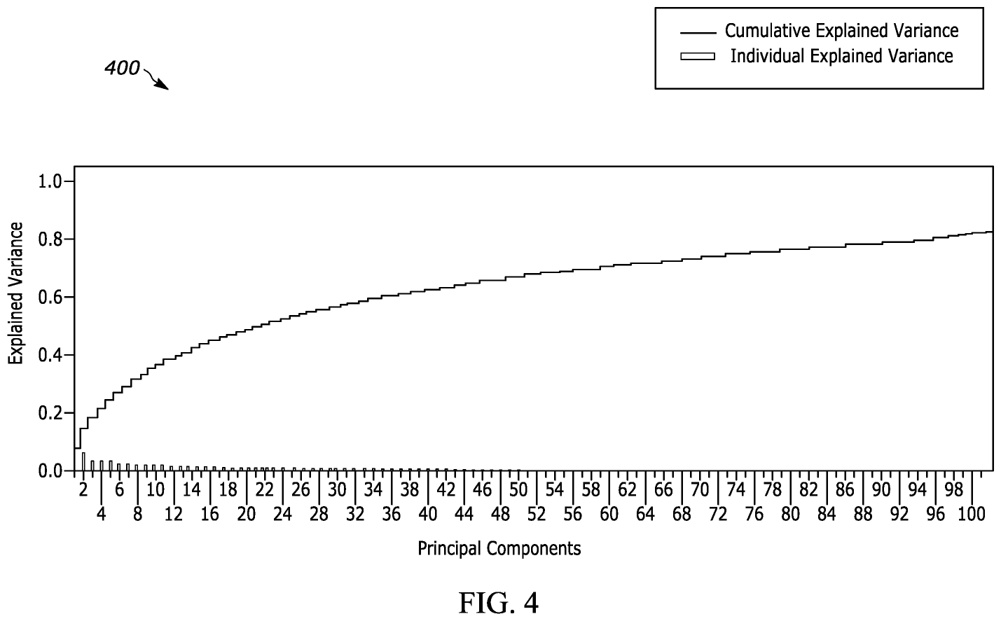

With reference to the graph 400 presented in FIG. 4, member profile dimension is reduced in this example to 100 according to principal component analysis (PCA) (100-D can represent almost 80% of original data).

If desired, t-Distributed Stochastic Neighbor Embedding (t-SNE) can be utilized to display the clustering results. T-SNE is a technique for dimensionality reduction that is particularly well suited for the visualization of high-dimensional datasets. This technique can be implemented via Barnes-Hut approximations, allowing it to be readily applied on large real-world datasets.

The Shopping Prediction Element 303

In this illustrative example the member segmentation element 302 provides both future item prediction 313 and item quantity prediction 314. For example, this information can be provided on a per-member basis to predict the contents (at least partially) of a future real or virtual shopping cart, both in terms of specific items acquired and their respective quantities. In this example, the shopping prediction element 303 utilizes a temporal convolutional network (TCN) (for further details regarding the latter, see the paper entitled “An empirical evaluation of generic convolutional and recurrent networks for sequence modeling” by Bai, Shaojie, J. Zico Kolter, and Vladlen Koltun at https://arxiv.org/abs/1803.01271, the contents of which are fully incorporated herein by reference). In this example these teachings also employ causal convolution of neural network approaches in combination with use of a dilated kernel in the resultant model. The latter approach enhances the performance of convolutional neural network-based time series tasks.

Each member's shopping history can be represented using pre-built indices of all items as a time series sequence. Although recurrent neural network techniques can be useful at sequential tasks, the applicant has determined that convolutional neural network techniques can achieve the same or better performance with less training time. In this example a temporal convolutional network facilitates time series prediction using convolutional neural network techniques. In this example the input is a sequence and the whole sequence data is used to predict the next states. More particularly, this approach uses a member's shopping history, in part, to predict the probabilities of buying an item.

The specific hyper parameters used in this model are as follows:

| Hyper Parameter | Value |
|---|---|
| Loss Function | Adaptive Hinge (pointwise |
| | with sampled negative samples) |
| Embedding Dimension | 256 |
| Kernel Width | 7 |
| Number of CNN Layers | 3 |
| Residual Link | Yes |
| Activation Function | ReLU |
| Dilation in Each Layer | [1, 2, 4] |
| Total Number of Training Epochs | 10 |
| Training Batch Size | 1024 |
| L2 Regularization | 0.0001 |
| Learning Rate | 1e−3 |
| Gradient Decent Optimizer | Adam |

The item quantity prediction 314 in this example uses an explicit feedback matrix factorization model. This approach uses latent vectors to represent both members and items. Their dot product gives a predicted score for a member-item pair. That score in turn represents the quantity of items. (Further information regarding a useful approach to feedback matrix factorization can be found in a paper entitled “Matrix factorization techniques for recommender systems” by Koren, Yehuda, Robert Bell, and Chris Volinsky and published at https://ieeexplore.ieee.org/document/5197422, the contents of which are hereby fully incorporated herein by this reference.)

The specific hyper parameters used in this model are as follows:

| Hyper Parameter | Value |
|---|---|
| Loss Function | RMSE |
| Embedding Dimension | 128 |
| Total Number of Training Epochs | 40 |
| Training Batch Size | 1024 |
| L2 Regularization | 1e−9 |
| Learning Rate | 1e−3 |
| Gradient Decent Optimizer | Adam |

In this example 40 epochs were trained with the model at the 15th epoch selected as the final model. (If desired, all of the resultant predictions can be written to a SQLite database 319 in advance to save on subsequent computing time.)

The Optimization Process Element 304

The aforementioned member segmentation information (in the form of a targeted member list 316) and the item/quantity predictions 317 are provided, in this example, to an optimization process element 304. In this example, this optimization process element 304 utilizes an optimization element 318 to optimize at least one promotion request 320 as posed, for example, by a user 321. For example, this can comprise, for a given budget B 315, solving for a and b in promotional statements such as “Spend $a and take $b off”.

Where N equals a set of targeted members and Si represents a prediction of each member's future shopping value, the optimization element 318 can be configured to optimize a and b to maximize budget utilization as follows:

$$B = f ( x ) = \{ \begin{matrix}{{\sum }_{i = 1}}^{N} N ( {S}_{{l}^{`}} - b ) {S}_{i} \geq a \\ {\sum }_{i = 1}^{N} {NS}_{i} , {S}_{i} < a\end{matrix}$$

The resultant prediction or predictions can then be provided to the user 321 via, for example, the aforementioned user interface 103.

Those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. An apparatus comprising:
a memory having time series acquisition history data for members of a predetermined group stored therein;
a control circuit operably coupled to the memory and configured to predict at least one future aggregation of items on a per-member basis by:
using machine learning to predict specific items in the at least one future aggregation of items, wherein the machine learning uses a training corpus comprising, at least in part, the time series acquisition history data;
using matrix factorization to predict a quantity of at least some of the specific items in the at least one future aggregation of items.

2. The apparatus of claim 1 wherein the machine learning comprises a convolutional neural network.

3. The apparatus of claim 2 wherein the convolutional neural network comprises a temporal convolutional neural network.

4. The apparatus of claim 3 wherein the temporal convolutional neural network comprises a causal dilated temporal convolutional neural network.

5. The apparatus of claim 1 wherein the control circuit is further configured to:
generate clusters of the members.

6. The apparatus of claim 5 wherein the control circuit is configured to generate the clusters of the members as a function, at least in part, of:
acquisition history;
item information;
category information;
member information.

7. The apparatus of claim 5 wherein the control circuit is configured to generate the clusters of the members via supervised clustering.

8. The apparatus of claim 5 wherein the control circuit is configured to generate the clusters of the members via unsupervised clustering.

9. The apparatus of claim 8 wherein the unsupervised clustering comprises using at least one of:
term frequency-inverse document frequency;
K-means clustering; and
singular value decomposition.

10. The apparatus of claim 5 wherein the control circuit is further configured to:
provide, via a user interface, offering strategies for the members as a function, at least in part, of:
the prediction of at least one future aggregation of items on a per-member basis;
the clusters of the members; and
at least one user-specified offering strategy limiting parameter.

11. A method comprising:
providing a memory having time series acquisition history data for members of a predetermined group stored therein;
by a control circuit operably coupled to the memory:
predicting at least one future aggregation of items on a per-member basis by:
using machine learning to predict specific items in the at least one future aggregation of items, wherein the machine learning uses a training corpus comprising, at least in part, the time series acquisition history data;
using matrix factorization to predict a quantity of at least some of the specific items in the at least one future aggregation of items.

12. The method of claim 11 wherein the machine learning comprises a convolutional neural network.

13. The method of claim 12 wherein the convolutional neural network comprises a temporal convolutional neural network.

14. The method of claim 13 wherein the temporal convolutional neural network comprises a causal dilated temporal convolutional neural network.

15. The method of claim 11 further comprising, by the control circuit:
generating clusters of the members.

16. The method of claim 15 wherein generating the clusters of the members comprises generating the clusters of the members as a function, at least in part, of:
acquisition history;
item information;
category information;
member information.

17. The method of claim 15 wherein generating the clusters of the members comprises generating the clusters of the members via supervised clustering.

18. The method of claim 15 wherein generating the clusters of the members comprises generating the clusters of the members via unsupervised clustering.

19. The method of claim 18 wherein the unsupervised clustering comprises using at least one of:
term frequency-inverse document frequency;
K-means clustering; and
singular value decomposition.

20. The method of claim 15 further comprising, by the control circuit:
providing, via a user interface, offering strategies for the members as a function, at least in part, of:
the prediction of at least one future aggregation of items on a per-member basis;
the clusters of the members; and
at least one user-specified offering strategy limiting parameter.
